(19) United States
(12) Patent Application Publication
(10) Pub. No.: US 2008/0121672 A1
(43) Pub. Date: May 29, 2008

(54) ADJUSTABLE VEHICLE RACK SYSTEM

(75) Inventors: Raymond R. Ripaldi, Manchester, NH (US); Peter Ripaldi, Hudson, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: RV Raxx LLC, Manchester, NH (US)

(21) Appl. No.: 11/556,761

(22) Filed: Nov. 6, 2006

(51) Int. Cl. B60R 9/06

(52) U.S. Cl. 224/498; 224/500; 224/512; 224/519; 224/485

(57) ABSTRACT

An adjustable rack system for a motor vehicle allows the user to transport and store various recreational items or accessories on the storage rack by selecting individual removable accessory storage devices for connecting with the rack system. The accessory devices are located on adjustable cross-members which allow the user to adjust the height and spacing between the various cross-members.

### TECHNICAL FIELD

The present invention relates to rack systems and more particularly, to an adjustable, multifunction rack system for mounting on a motor vehicle.

### BACKGROUND INFORMATION

Many people today travel extensively for recreational purposes. This travel often necessitates bringing along recreational equipment and supplies such as bicycles, kayaks, canoes, barbecue grills, clothes drying racks and all types of other recreational related equipment.

Whether one is traveling with a recreational vehicle such as a motor home or camper, or traveling with an SUV, pickup truck or other type of motor vehicle, room for taking along recreational equipment is often very limited. It is not unusual to see motor vehicles, campers and motor homes loaded about roofs, rear areas and the like with various recreational items and equipment. In addition, once you are at your destination, it is often desirable to have a place to store the recreational equipment when not in use so as to keep the surrounding area uncluttered. It is especially desirable to be able to store or travel with recreational equipment so as not to interfere with the normal operation of the motor vehicle if possible.

There have been some attempts at providing storage racks for motor vehicles. Examples include bicycle racks and kayak racks. The problem with these types of storage racks is that they are dedicated to one particular recreational item and are not user adaptable to other recreational items. A bicycle rack can only be used to store and transport bicycles. The same is true for kayak racks mounted on top of vehicles. Many of these racks are difficult to use and inconvenient places for example, on the roof of a motor vehicle. Accordingly, these dedicated racks do not allow the user to purchase a standard rack and then to subsequently purchase storage attachments for the particular recreational items which that user wishes to utilize.

Accordingly, a need exists for an adjustable, compact storage rack which can attach to the back of a motor vehicle or recreational vehicle and which can store multiple various recreational items and which can be configured, by the user, for the storage and transportation of those recreational items used by that particular user.

### SUMMARY

The present invention features an adjustable rack system for use with a motor vehicle such as a motor home, camper, SUV or other similar motor vehicle. The adjustable rack system includes a base and first and second tubular upright members. The first and second tubular upright members include first and second ends. The first and second tubular upright members are releasably coupled to the base member proximate the first end of the tubular member, and extend vertically parallel and spaced apart from one another. Each of the first and second tubular upright members include a plurality of spaced apart holes extending through each of the first and second tubular upright members. The holes in the first tubular upright member are horizontally aligned with the holes in the second tubular upright member.

The invention further includes at least one adjustable cross-member. The at least one adjustable cross-member includes first and second tubular connector members located proximate the first and second ends of the at least one cross-member. The first and second tubular connector members are configured to fit over and around the first and second tubular upright members. The at least one adjustable cross-member typically further includes a connecting member disposed between and coupled to the first and second tubular connector members. Each of the first and second tubular connector members include at least one releasable coupling device which are configured to securely interconnect the first and second tubular connector members with one of the holes in each of the first and second tubular upright members. Each of the releasable coupling devices are connected together by a coupling device release member, such as a cable, so as to be releasable by engaging or pulling on the coupling device release member.

The invention further includes at least first and second attachment devices. Each of the first and second attachment devices include a connecting member coupling region located at or near a first end of each of the first and second attachment devices. The connecting member coupling regions are configured for interfacing with the connecting member of the cross-member, for permitting the first and second attachment devices to move horizontally along the connecting member between the first and second tubular connecting members. Each of the first and second attachment devices include a connecting member securing device located proximate the connecting member coupling region and configured for movement between a first and a second position. In a first position, the connecting member securing device generally prevents the first and second attachment while in a second position for generally allowing movement of the first and second attachment devices horizontally along the connecting member.

The first and second attachment devices further include an accessory attachment region disposed opposite the connecting member coupling region and are configured for removably interconnecting with any one of a plurality of accessory holders. Examples of accessory holders include bike racks, cargo trays, close lines, flight pole holders and kayak holders. Each accessory attachment region includes an accessory storage holder retaining device for releasably coupling any one of the accessory holders to the accessory attachment region of the first and second attachment devices.

### BRIEF DESCRIPTION OF THE DRAWINGS

These and other features and advantages of the present invention will be better understood by reading the following detailed description, taken together with the drawings wherein:

FIG. 1 is schematic plan view of an adjustable rack system in accordance with the preferred embodiment of the present invention; and

FIGS. 2A-2C are schematic representations of various accessory devices which can be used with the adjustable rack system in accordance with the present invention.

### DETAILED DESCRIPTION OF THE PREFERRED EMBODIMENTS

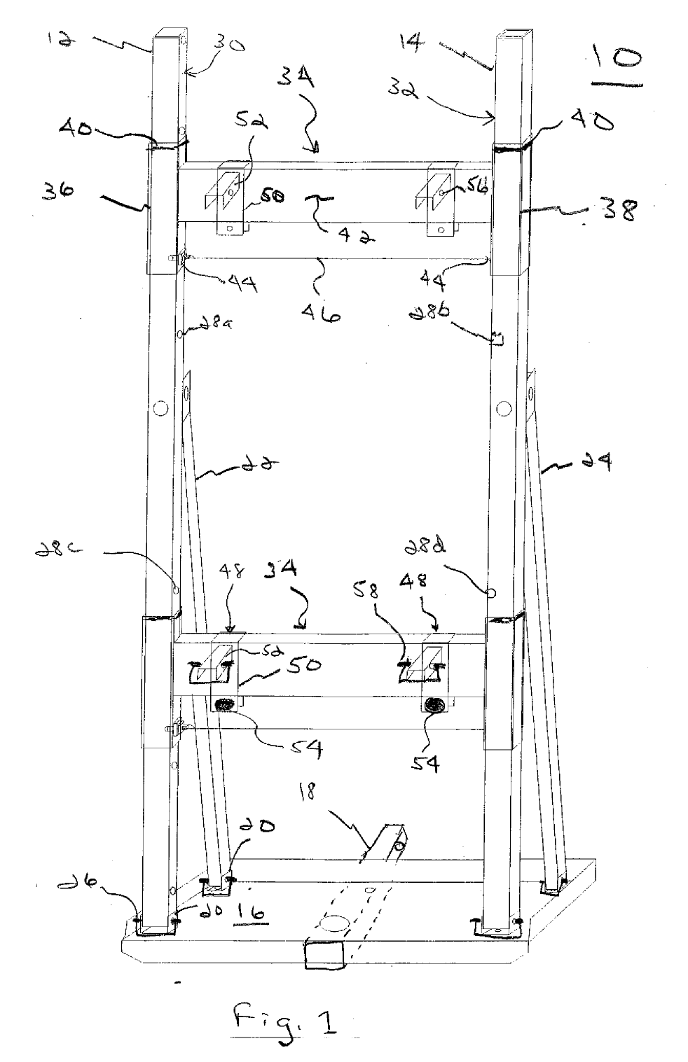

The present invention features an adjustable rack system 10, FIG. 1, for use with a motor vehicle such as a motor home, camper or other motorized or towed vehicle. The adjustable rack system can includes first and second tubular upright members 12 and 14. The tubular upright members 12, 14 are typically approximately 6 feet tall and in the exemplary embodiment, are made of 1½ inch square tubular aluminum approximately ⅛″ thick.

The tubular upright members 12 and 14 are coupled proximate a first end to base member 16. In the preferred embodiment, the base member 16 is approximately 24 inches wide by 7 inches deep and made all the painted steel plate. Using U-shaped bolts, brackets or a second plate (not shown), the base member 16 may be bolted to a 4 inch square of bumper typically provided on motor homes or campers. Alternatively, a trailer hitch interconnection member 18 may be provided which allows the adjustable rack system base member 16 and the rack itself to be supported by inserting the interconnection member 18 into a trailer hitch on a motor vehicle.

The base member 16 further includes a number of brackets 20 which serve to support the tubular upright members 12, 14 and the support members 22, 24. The brackets 20 are U-shaped and include a whole at each side into which may be inserted a pin clip or the like 26 to releasably couple the first and second tubular upright members 12, 14 and the first and second supports 22, 24 to the base member 16. The first and second supports 22, 24 are coupled to the first and second tubular upright members 12, 14 at a height of approximately 40 inches from the base member 16.

The first and second tubular upright members 12, 14 include a plurality of holes 28 which extend into the tubular members 12, 14 from an inside region 30, 32 of each of the first and second upright members. Pairs of holes such as holes 28a and 28b, and pair 28c and 28d are a lined horizontally such that the various pairs of holes made interface with the cross-member retaining devices, as will be explained in greater detail below. Holes 28 are typically generally evenly spaced along the length of the tubular upright members 12, 14 typically approximately 9 inches apart vertically.

The adjustable rack system 10 includes at least one cross-member 34 although preferably two cross-members are provided. Each cross-member 34 includes first and second tubular connector member portions 36, 38 which are configured to fit over and around the tubular upright members 12, 14. In the preferred embodiment, a tubular shaped plastic insert 40 is provided and is disposed between the first and second tubular connector member portions 36, 38 and the tubular upright members 12, 14, to facilitate sliding of the cross-members 34 up and down the upright members 12, 14.

Each cross-member 34 also includes a connecting member 42 which is typically a “C” shaped channel member disposed between and connected to the first and second tubular connector member in portions 36, 38. The cross-member 34 also includes first and second releasable coupling devices 44 located in each of the first and second tubular connector member portions 36, 38. The releasable coupling devices are typically a spring loaded pins which engage with pairs of holes 28 in the tubular upright members 12, 14 and serve to support the cross-member 34 between the upright members 12, 14. In the preferred embodiment, the releasable coupling devices 44 of each cross-member are connected by a coupling device release member 46, such as a cable, so that a user simply pulls on the cable to release the two releasable coupling devices 44 which are part of each cross-member 34, thereby allowing the cross-member 34 to be slid up and down along the length of the tubular upright members 12, 14.

Located on each cross-member 34 are one or more attachment devices 48. The attachment devices 48 include a connecting member coupling region 50 and an accessory device attachment region 52. The connecting member coupling region 50 is typically a “C” shaped member which fits over the connecting member 42 of the cross-member 34. Each connecting member coupling region 50 also typically includes a connecting member securing device 54 which, in the preferred embodiment, is a bolt having a large easy to turn knob which is threaded into a nut (not shown) inserted or welded onto the back portion of the connecting member coupling region 50. The connecting member securing devices 50 allow the attachment devices 48 to be moved or secured anywhere along the width of the connecting member 42 of the cross-member 34.

Attachment devices 48 also include an accessory attachment region 52 in the form of a “C” shaped channel. Each accessory attachment region 52 includes a hole 56 into which may be inserted a clip pin or the like 58 to secure an accessory holder (not shown in this figure) to the accessory attachment region 52 of the attachment device 48.

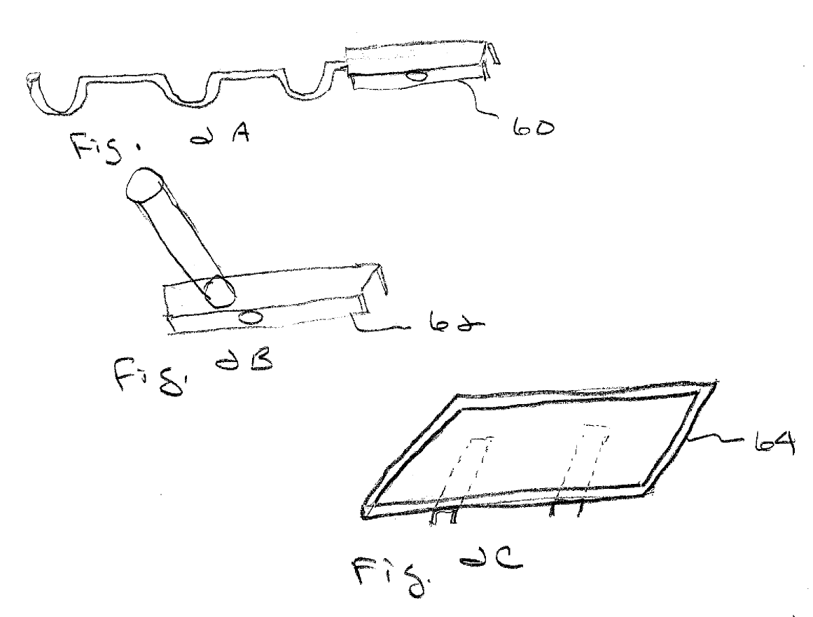

Examples of various accessory holders include, but are not limited to, a bicycle holder 60, FIG. 2A, a flag holder 62, FIG. 2B and a cargo tray 64, FIG. 2C. Other potential accessory holders which are not shown but would be within the ordinary skill of someone in the yard include a kayak holder, close line holder and the like.

Accordingly, the present convention provides a novel adjustable rack system for a motor vehicle which allows the user to transport and store various accessory devices on the storage rack by selecting individual removable accessory storage devices for connecting with the rack system. The accessory devices are located on adjustable cross-members which allows the user to adjust the height and spacing between the various cross-members.

Modifications and substitutions by one of ordinary skill in the art are considered to be within the scope of the present invention, which is not to be limited except by the following claims.

The invention claimed is:

1. An adjustable rack system for use with a motor vehicle, comprising:
a base member;
first and second tubular upright members, said first and second tubular upright members including first and second ends, said first and second tubular upright members releasably coupled to said base member proximate said first end and extending vertically parallel and spaced apart from one another, each said first and second tubular upright members including a plurality of spaced apart holes extending through each of said first and second tubular upright members, said holes in said first tubular upright member horizontally aligned with said holes in said second tubular upright member;
at least one adjustable cross-member, said at least one adjustable cross-member including first and second tubular connector members disposed proximate first and second ends of said at least one cross-member, said first and second tubular connector members configured to fit over and around said first and second tubular upright members, said at least one adjustable cross-member further including a connecting member disposed between and coupled to said first and second tubular connector members, each of said first and second tubular connector members including at least one releasable coupling device, each said releasable coupling device configured to securely interconnect said first or second tubular connector member with one of said holes in each of said first and second tubular upright members, each said releasable coupling device connected together by a coupling device release member so as to be releasable by engaging said coupling device release member; and
at least first and second attachment devices, each of said first and second attachment devices including a connecting member coupling region disposed proximate a first end of each of said first and second attachment devices, and configured for interfacing with said connecting member of said at least one cross-member, for permitting said first and second attachment devices to move horizontally along said connecting member between said first and second tubular connecting members, each of said first and second attachment devices including a connecting member securing device disposed proximate said connecting member coupling region and configured for movement between a first and a second position, said first position for generally preventing said first and second attachment devices from moving horizontally along said connecting member and said second position for generally allowing movement of said first and second attachment devices horizontally along said connecting member, said first and second attachment devices further including an accessory attachment region disposed opposite said connecting member coupling region and configured for removably interconnecting with any one of a plurality of accessory holders, each said accessory attachment region including an accessory storage holder retaining device for releasably coupling any one of said plurality of accessory holders to said accessory attachment region of said first and second attachment devices.

2. The adjustable rack system of claim 1 wherein said base member is coupled to a bumper of a motor vehicle.

3. The adjustable rack system of claim of 1 wherein said base member is configured to interconnect with a trailer hitch of a motor vehicle.

4. The adjustable rack system of claim 1 wherein the first and second upright members are generally square tubular members.

5. The adjustable rack system of claim 1 further including first and second tubular upright member supports, each of said first and second tubular upright member supports including a first end coupled to said base member and a second end coupled to said first and second tubular upright members respectively.

6. The adjustable rack system of claim 5 wherein said second end of said first and second tubular upright member supports is coupled to said first and second tubular upright members at some point between said first and second ends of said tubular upright members.

7. The adjustable rack system of claim 1 wherein said at least one adjustable cross member connecting member includes a “C” channel shape.

8. The adjustable rack system of claim 1 wherein said releasable coupling devices include a spring loaded pin.

9. The adjustable rack system of claim 1 wherein said accessory holders are selected from the group consisting of a bicycle holder, a kayak holder, a flag holder, a cargo tray holder and a closed line holder.

10. The adjustable rack system of claim 1 wherein each of said first and second tubular connector members of said at least one adjustable cross-member include a plastic tubular sleeve disposed between said first and second tubular connector members and said first and second tubular upright members around which said first and second tubular connector members are disposed.

11. The adjustable rack system of claim 1 wherein said coupling device release member includes a cable connected to each coupling device.
